(19) United States
(12) Patent Application Publication
(10) Pub. No.: US 2006/0092547 A1
(43) Pub. Date: May 4, 2006

(54) Method and a device for recording and reproducing data onto and from a magnetic tape

(75) Inventors: Shinji Kawakami, Ibaraki-shi (JP); Shihoko Takashima, Ibaraki-shi (JP)

Correspondence Address: BIRCH STEWART KOLASCH & BIRCH, PO BOX 747, FALLS CHURCH, VA, 22040-0747, US

(73) Assignee: HITACHI MAXELL, LTD., Ibaraki-shi (JP)

(21) Appl. No.: 11/239,239

(22) Filed: Sep. 30, 2005

(30) Foreign Application Priority Data
Oct. 4, 2004 (JP) 2004-291371

(51) Int. Cl. G11B 15/18; G11B 5/584

(52) U.S. Cl. 360/71; 360/77.12

(57) ABSTRACT

A recording/reproducing method and a recording/reproducing device for magnetic tapes are less involved displacements between recording track and reproducing head even upon changes in the widthwise size of the magnetic tape, and capable of recording and reproducing data without causing errors, thus being ready for recording density enhancement of magnetic tapes. In both data recording and data reproduction, the tension of the magnetic tape is controlled so that absolute values of displacements between a pair of servo heads and a plurality of servo tracks corresponding to these servo heads are minimized.

### BACKGROUND OF THE INVENTION

The present invention relates to a recording/reproducing method and a recording/reproducing device for magnetic tapes, the method and device being capable of managing size changes of magnetic tapes.

Magnetic tapes are used in various applications such as audio tapes, video tapes and computer tapes. Particularly in the field of data backup tapes, magnetic tapes having recording capacities of 200 GB or more per reel have been commercialized along with increasing mass storage of hard disks, which are targeted for backup. Further, mass-storage backup tapes which will go beyond 1 TB from this time forward have been proposed, for which implementation of higher recording densities is indispensable.

For the purpose of increasing the capacity of magnetic tapes, it is conceivable, for example, to decrease the thickness of a tape as a whole to thereby elongate the tape length per reel, or to reduce the recording wavelength to thereby increase the recording density of the tape in its longitudinal direction, or to narrow the recording track width to thereby increase the recording density of the tape in its widthwise direction. Also, for implementation of higher recording densities of tapes, it is preferable to use not conventional inductive heads but magnetoresistance effect heads (MR heads) using high-sensitivity magnetoresistance elements.

As the recording track width goes narrower with increasing recording density of the magnetic tape, the reproducing head can no longer accurately follow the recording tracks due to positional changes in the widthwise direction of the magnetic tape in data recording and reproduction, so that errors are more likely to occur. Thus, there has been provided a system that uses servo tracks (a system having the servo method) in combination, as an example.

The servo method comes in the magnetic servo method and the optical servo method, the former being a method in which a servo signal is formed on a magnetic layer by magnetic recording and read magnetically to do servo tracking, and the latter being a method in which a servo signal made from a recessed portion array is formed on a back coat layer by laser irradiation or the like and then read optically to perform servo tracking. In data recording and reproducing by these servo systems, even if the position of the magnetic tape has changed widthwise, accurate information recording and reproduction can be achieved, for example, by reading a servo signal written on the magnetic tape with a servo head, and then controlling the magnetic-tape widthwise position of a head unit, which includes at least a data recording head (hereinafter, referred to also as ‘recording head,’ simply) and a data reproducing head (hereinafter, referred to also as ‘reproducing head,’ simply), according to the read servo signal so that the recording head and the reproducing head are made to follow the data tracks.

Meanwhile, since increased recording densities of magnetic tapes lead to decreases in the recording track width or decreases in the difference (off-track margin) between recording track width and reproducing track width, there is a fear that not only positional changes in the direction of the magnetic tape but also even slight size changes in the widthwise direction of the magnetic tape would cause errors in data reproduction. Against such size changes in the widthwise direction of the magnetic tape, the difference between recording track width and reproducing track width would be comparatively larger hitherto (i.e., the off-track margin would be large enough), thus it having been unlikely that errors occur due to size changes of the magnetic tape or part of recorded data becomes impossible to reproduce. It is noted that slight size changes in the widthwise direction of the magnetic tape specifically refer to, for example, size changes due to creeps, or size changes in the widthwise direction of the magnetic tape due to effects of temperature and humidity, because, in the case of reservation of the magnetic tape in a taken-up state, the magnetic tape would be kept burdened with the take-up tension over the overall length of the magnetic tape and moreover central portion of the wound magnetic tape would have winding pressure steadily applied.

As techniques related to such issues as described above, there have conventionally been proposed a servo tracking method which allows reproducing tracks to be more accurately followed even if the magnetic tape width has extended or contracted (referring to JP 2003-173507 A), a method of controlling the tape tension by detecting the tape width (referring to JP 2001-35046 A), and the like.

Patent Document 1: JP 2003-173507 A

Patent Document 2: JP 2001-35046 A

However, on condition that the recording track width goes even narrower than ever in the future as a result of further increased recording densities of magnetic tapes, measures for the above-described size changes in the widthwise direction of the magnetic tape in addition to positional change in the widthwise direction of the magnetic tape will be of importance. That is, as the recording track width goes narrower, displacements between recording track and reproducing head may occur during data reproduction also due to slight size changes in the widthwise direction of the magnetic tape, consequently making it relatively more probable that errors may occur. Accordingly, in order to achieve increased recording densities of the magnetic tape, there is a need for preventing such displacements due to size changes in the tape widthwise direction as described above. Unfortunately, it has been difficult for conventional servo tracking techniques to manage the issues described above.

### SUMMARY OF THE INVENTION

The present invention being intended for a solution to the above-described issues, an object of the invention is to provide a recording/reproducing method and a recording/reproducing device for magnetic tapes, both of which involve less positional changes between recording track and reproducing head even upon occurrence of changes in the widthwise size of the magnetic tape, and are capable of recording and reproducing of data without causing errors, and moreover capable of managing increased recording densities of the magnetic tape.

There is a correlation between tension (tape tension) and tape width size of the magnetic tape, where the latter tape width size can be changed by changing the former tape tension. By making use of this correlation, in order to solve positional changes due to such size changes in the tape widthwise direction as described above, the present invention has adopted means for actively changing the tape width size by controlling the tape tension, which means has drawn no attention hitherto.

That is, according to the present invention, there is provided a recording/reproducing method for magnetic tapes, by which data recording and reproduction are performed on a magnetic tape having a plurality of servo tracks with a head unit which includes at least a pair of servo heads and a plurality of data heads located between these servo heads, the method comprising the step of controlling tension of the magnetic tape in both data recording and data reproduction so that absolute values of displacements between the pair of servo heads and a plurality of servo tracks corresponding to these servo heads, respectively, are minimized.

Also according to the present invention, there is provided a recording/reproducing device for magnetic tapes, by which data recording and reproduction are performed on a magnetic tape having a plurality of servo tracks with a head unit which comprises at least a pair of servo heads and a plurality of data heads located between these servo heads, the device comprising: displacement detection means for detecting a displacement between servo head and servo track; and tension control means for controlling tension of the magnetic tape, wherein the tension control means controls tension of the magnetic tape in both data recording and data reproduction so that absolute values of displacements between the pair of servo heads and a plurality of servo tracks corresponding to these servo heads, respectively, are minimized based on a detection result by the displacement detection means.

According to the recording/reproducing method and the recording/reproducing device for magnetic tapes constructed as described above, in data recording and reproduction, an absolute value of displacement between servo head and servo track is detected, and based on the detection result, the tape tension is controlled so that absolute values of displacements between the pair of servo heads in the head unit and the plurality of servo tracks on the magnetic tape are minimized. As a result, since any displacement between servo head and servo track is corrected, it become possible to record data at correct positions of the data tracks and also correctly read the data even with the width size of the magnetic tape changed, that is, to perform data recording and reproduction without causing errors.

According to the present invention, even if the width size of the magnetic tape has changed, the tape tension is controlled so that displacements between servo heads and servo tracks are minimized in both data recording and data reproduction. Thus, it becomes possible to record and reproduce data for the magnetic tape without causing errors.

### BRIEF DESCRIPTION OF THE DRAWINGS

The present invention will be further described with reference to the accompanying drawings wherein like reference numerals refer to like parts in the several views, and wherein:

FIG. 1 is a schematic view for explaining an example of a servo system to be used for magnetic tape, showing a state that recording tracks and servo tracks are alternately provided on the magnetic recording surface (magnetic layer) of the magnetic tape;

FIG. 2 is a schematic view of an example of placement of a head provided in the head unit, showing a portion corresponding to I portion of FIG. 1;

FIG. 3 is a schematic view of an example of servo tracks written on the magnetic tape as well as the head unit, showing a portion corresponding to II portion of FIG. 1;

FIG. 4 is a view for explaining an embodiment of the present invention, showing an example of the graph of the correlation between tape tension and displacement between servo head and servo track; and

FIG. 5 is a flowchart showing the control procedure of tape tension in the embodiment of the invention.

### DETAILED DESCRIPTION OF THE PREFERRED EMBODIMENTS

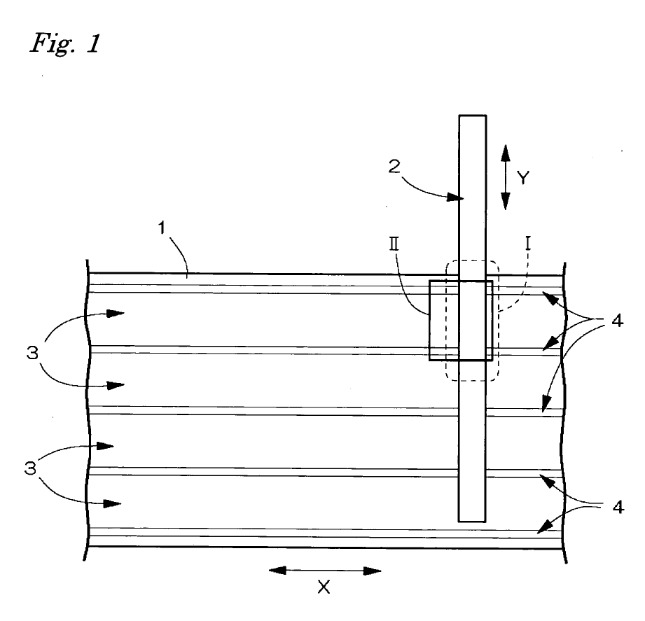

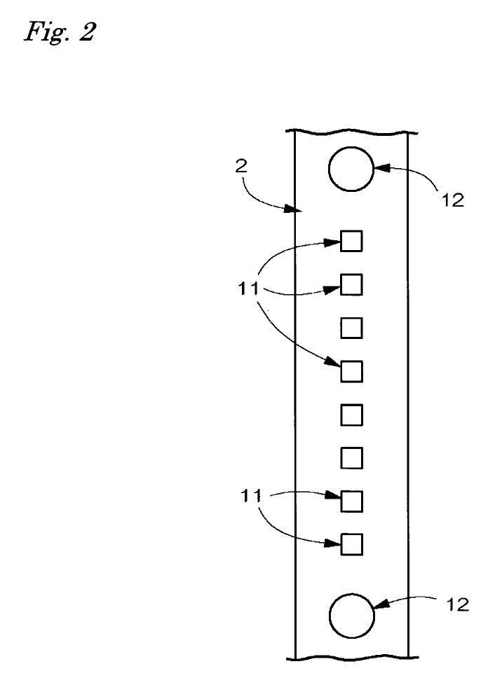

The present invention is targeted for recording/reproducing method and recording/reproducing device for recording and reproducing data while performing servo tracking on a magnetic tape having data tracks and servo tracks. The tracking servo method in this case may be either a magnetic servo method or an optical servo method. Below given is a description on a case where the present invention is applied to a system in which data recording and reproduction is performed while servo tracking is being performed on a magnetic tape 1 by the magnetic servo method by using a head unit 2 as shown in FIGS. 1 and 2. In addition, the basic concept of the present invention lies in controlling tensions of magnetic tapes, respectively, so that absolute values of displacements between a pair of servo heads and their corresponding plural servo tracks come to minimums. Therefore, the present invention is applicable also to magnetic tape recording/reproducing systems that adopt the optical servo method only if the system is capable of detecting the displacements.

As shown in FIG. 1, the magnetic tape 1, which is recorded and reproduced by a recording/reproducing device of the invention, has a plurality of servo tracks 4 extending along its longitudinal direction (X direction in the figure), and data tracks 3 positioned therebetween and extending also along its longitudinal direction between.

The recording/reproducing device of the invention, as illustrated in FIG. 2, has the head unit 2 including data recording and reproducing heads 11 and a pair of servo heads 12, 12. Generally, the data recording and reproducing heads 11 are positioned between the servo heads 12, 12. The head unit 2, which is mounted on a drive control unit, can be positionally controlled in the tape width direction (Y direction shown in FIG. 1).

In the event of size changes caused by creeps of the magnetic tape during its reservation in a taken-up state, or size changes in the magnetic-tape widthwise direction caused by effects of temperature and humidity, there occur changes in the distance between a pair of servo tracks 4, 4 that are to be read by the pair of servo heads 12, 12, so that positional displacements occur between the servo tracks 4 and their corresponding servo heads 12.

In the present invention, for correction of such positional displacements, the tape tension is controlled during both data recording and data reproducing in the manner shown below.

First, in data recording and reproduction, while the servo tracks 4, 4 pre-written on the magnetic tape 1 are followed by the pair of servo heads 12, 12 provided in the head unit 2, data is recorded and reproduced on and on and, simultaneously with this, any displacements between the servo tracks 4 and the servo head 12 are detected.

Now, the displacement detection method between servo heads and servo tracks (detection means for displacements between servo heads and servo tracks) is explained.

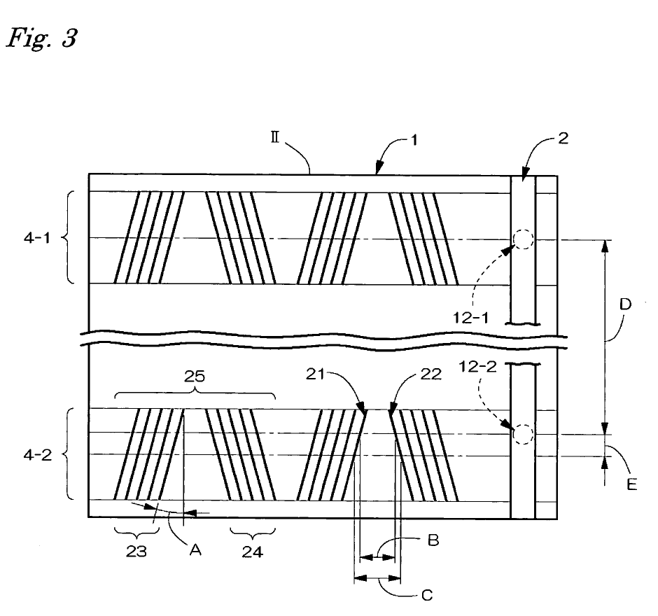

The servo tracks 4, as shown in FIG. 3, are formed by servo signals 21, 22 each having an inclination A. These servo signals 21, 22 make up a plurality of servo signal groups 23, 24 by their members having the same inclinations, respectively. These servo signal groups 23, 24 have been written on the magnetic tape as servo signal groups 25 having a symmetrical inverted-and-separated V-like shape. Since servo signals are written in a symmetrical inverted-and-separated V-like shape having a certain inclination A as shown above, and since the magnetic tape 1 is conveyed at a constant speed longitudinally for reading of the servo signals, the passage time of the servo signals 21, 22 having different inclinations is determined by widthwise positions of the servo heads 12.

For instance, in a case where the magnetic tape 1 has expanded widthwise as shown in FIG. 3, if a servo head 12-1 is located at a center position of a servo track 4-1, then another servo head 12-2 is shifted upward in the figure by a tape widthwise distance E from the center position of a servo track 4-2. In this case, the distance between the servo head 12-1 and the servo head 12-2 is designated by reference character D in the figure.

A longitudinal distance B between neighboring servo signals 21, 22 is calculated by the passage time at which the servo head 12-2 passes through between the servo signal 21 and the servo signal 22, and a displacement E between servo head and servo track is calculated according to the following equation (1) by a difference between the longitudinal distance B of neighboring servo signals 21, 22 and the longitudinal distance C of neighboring servo signals 21, 22 on the center line of the servo track as well as by the inclination A of the servo signals:
E=(C-B)/(2·tan A) (1)

The displacement between servo head and servo track in data recording and reproduction detected by such displacement detection method is corrected so that its absolute value becomes as small as possible, by controlling the tape tension with tension control means.

Now, the tape tension control method (tension control means) is explained below.

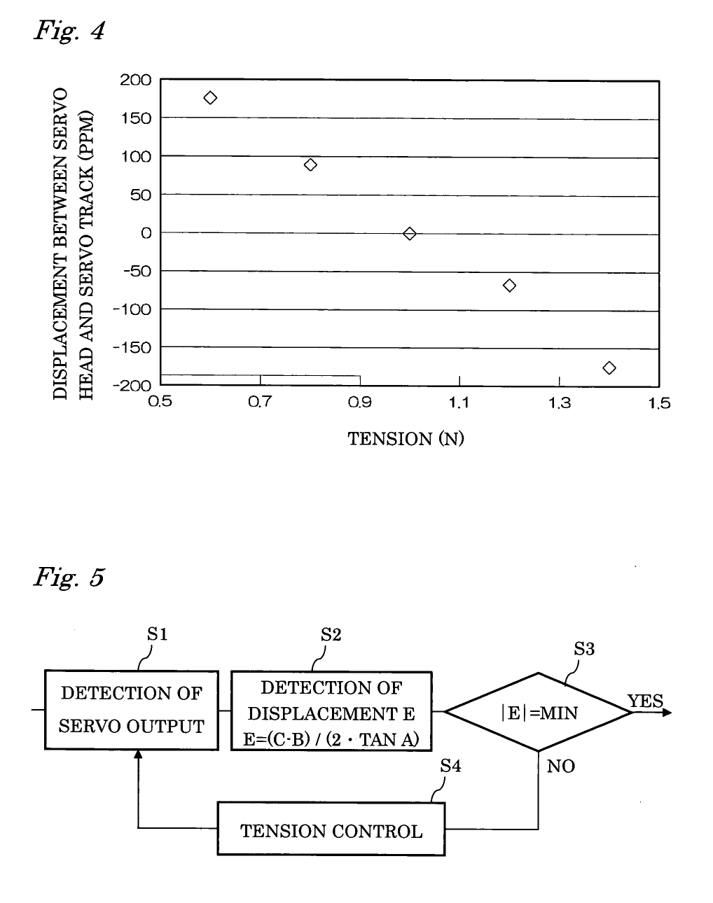

Generally, as shown in FIG. 4, there can be seen a correlation between tape tension and the displacement between servo head and servo track. It is noted that FIG. 4 shows displacements between servo heads and servo tracks relative to changes in tape tension on a basis of a reference displacement resulting when the tension is 1N. The magnetic tape in use is 9.0 μm thick and ½ inch wide.

In the present invention, by exploiting such a correlation, tape width size is actively changed by controlling the tape tension. As the procedure in this case, as shown in FIG. 5, a servo output is first detected (step S1), and a displacement E is calculated from the resulting value by the foregoing method (step S2). Then, if the absolute value (|E|) of the calculated displacement E is at a minimum (min), the then current tape tension is held; otherwise, the tape width size is changed by controlling the magnetic tape tension in data recording and reproduction by the tension control means so that |E|=min (step S3 and step S4). That is, when the tape width size has expanded, the tape width size is corrected so as to become smaller by increasing the tape tension in the longitudinal direction (the tape running direction) of the magnetic tape. Meanwhile, when the tape width size has contracted, the tape width size is corrected so as to become larger by decreasing the tape tension in the longitudinal direction of the magnetic tape. By such correction of the tape width size by means of tape tension, the displacement between servo head and servo track is minimized.

The tape tension control may be implemented by, for example, a method of changing the tape tension to an arbitrary one until the passage time becomes equal among servo signals, or a method of previously determining the correlation between tape tension and displacement between servo head and servo track, or the like. However, without limitations to these methods, other methods may of course be used.

The tape tension control may be implemented by, for example, a method in which pinch rollers and capstans are provided at sites corresponding to both sides of the head unit in the tape running route and their rotating speeds are controlled, a method of controlling reel rotating torque on the drive side and/or cartridge side, or the like. However, these methods are not limitative.

As described above, the tape width size can actively be changed by detecting any displacement between servo head and servo track and controlling the tape tension during data recording and reproduction, so that any displacement between servo head and servo track can be corrected. As a result, it becomes possible to perform data recording and reproduction without causing errors, thus providing for recording density enhancement of magnetic tapes.

Also, the MR head preferably required for recording density enhancement of magnetic tapes is so structured that air in accompaniment to the tape is cut at head end faces, causing the air pressure at central portion of the head to decrease, so that head contact between magnetic tape and head is ensured. Therefore, it can be said that the MR head involves less detrimental effects such as head contact failures upon changes in tape tension, as compared with conventional inductive heads in which the head contact is ensured by the balance among tape tension, head configuration and tape rigidity. That is, also in terms of this point, the present invention can be said to be reasonable for provision for recording density enhancement of magnetic tapes.

It has conventionally been practiced only to perform the positional control over the servo unit itself so that the servo head is enabled to accurately follow the servo track, and it has never been conceived hitherto to actively change the tape width. The present invention can be regarded as a never-available-before concept that the tape width size is actively changed by controlling the tape tension.

The more the tape becomes thin, the more the size changes in magnetic tapes is affected by changes in tension. Therefore, the present invention is more useful for the thinner magnetic tapes.

The present invention differs from the aforementioned inventions of JP 2003-173507 A and JP 2001-35046 A in the following points.

The invention of JP 2003-173507 A is characterized in that, based on output values of a servo signal and a data signal, the position of the reproducing head is controlled so that those output values become higher, thus making it possible to follow the recording tracks even if the magnetic tape has expanded or contracted. Comparing this with the present invention, although both overlap with each other in proposing a solution for size changes in the magnetic tape, yet the present invention proposes controlling the tape width itself by changing the tape tension against size changes of the magnetic tape by exploiting the property that increasing the longitudinal tension of the tape causes the tape width to decrease and, conversely, decreasing the longitudinal tension of the tape causes the tape width to increase. Thus, the present invention is absolutely different in basic concept from the invention of JP 2003-173507 A, in which the position of the head itself is controlled upon expansion and contraction of the magnetic tape.

The invention of JP 2001-35046 A relates to a flexible-tape tension detection method, which is characterized by determining a tension value based on a tape width change, as well as to a flexible-tape tension control method, which is characterized by controlling the flexible-tape tension so that the tape width becomes a target tape width corresponding to a desired tension value. The invention of JP 2001-35046 A is purposed to perform stable running or even winding, thus different in purpose from the present invention. Also, JP 2001-35046 A attributes changes in tape width only to changes in tension, and gives no considerations to, for example, the issue of tape cutting accuracy by slitters or the like, the issue of magnetic tape size changes due to reservation state or temperature and humidity, which is an target issue of the present invention, and the like.

As described above, according to the present invention, even if the magnetic tape has changed in size, any displacement between servo head and servo track is corrected by performing tension control during data recording, thereby making it possible to record data at correct positions of data tracks. Similarly, also during data reproduction, any displacement between servo head and servo track is corrected similarly by performing tension control during data reproduction, thereby making it possible to read data correctly. Thus, it becomes possible to record and reproduce data without causing errors. The present invention makes it practicable to provide a recording/reproducing method as well as a recording/reproducing device for magnetic tapes by which the recording density enhancement of magnetic tapes can be achieved.

Although the present invention has been fully described by way of examples with reference to the accompanying drawings, it is to be noted that various changes and modifications will be apparent to those skilled in the art. Therefore, unless otherwise such changes and modifications depart from the scope of the present invention, they should be construed as being included therein.

What is claimed is:

1. A recording/reproducing method for magnetic tapes, by which data recording and reproduction are performed on a magnetic tape having a plurality of servo tracks with a head unit which includes at least a pair of servo heads and a plurality of data heads located between these servo heads, the method comprising the step of controlling tension of the magnetic tape in both data recording and data reproduction so that absolute values of displacements between the pair of servo heads and a plurality of servo tracks corresponding to these servo heads, respectively, are minimized.

2. A recording/reproducing device for magnetic tapes, by which data recording and reproduction are performed on a magnetic tape having a plurality of servo tracks with a head unit which comprises at least a pair of servo heads and a plurality of data heads located between these servo heads, the apparatus comprising:
displacement detection means for detecting a displacement between servo head and servo track; and
tension control means for controlling tension of the magnetic tape, wherein
the tension control means controls tension of the magnetic tape in both data recording and data reproduction so that absolute values of displacements between the pair of servo heads and a plurality of servo tracks corresponding to these servo heads, respectively, are minimized based on a detection result by the displacement detection means.
